(19) United States
(12) Patent Application Publication
(10) Pub. No.: US 2024/0327637 A1
(43) Pub. Date: Oct. 3, 2024

(54) Thermoplastic Resin Composition and Molded Product Formed Therefrom

(71) Applicant: LOTTE CHEMICAL CORPORATION, Seoul (KR)

(72) Inventors: Cheol Hoon JANG, Uiwang-si (KR); Chan Moo PARK, Uiwang-si (KR); Sang Hwa LEE, Uiwang-si (KR); Bong Jae LEE, Uiwang-si (KR)

(21) Appl. No.: 18/579,939

(22) PCT Filed: Jul. 8, 2022
(86) PCT No.: PCT/KR2022/009898

§ 371 Date: Jan. 17, 2024

(30) Foreign Application Priority Data
Jul. 30, 2021 (KR) 10-2021-0100355

(51) Int. Cl. C08L 69/00; C08K 5/51; C08K 7/14

(52) U.S. Cl. CPC C08L 69/00; C08K 5/51; C08K 7/14; C08L 2203/30; C08L 2205/03

(57) ABSTRACT

A thermoplastic resin composition of the present invention comprises: about 100 parts by weight of a polycarbonate resin; about 20 to about 55 parts by weight of a polyphenylene ether resin; about 10 to about 55 parts by weight of glass fibers; about 1 to about 35 parts by weight of a styrene-ethylene/butylene-styrene copolymer; and about 0.2 to about 4 parts by weight of dihydro-9-oxa-10-phosphaphenanthrene-10-oxide (DOPO). The thermoplastic resin composition has excellent impact resistance, flowability, and appearance characteristics and a low dielectric constant and dielectric loss factor.

### TECHNICAL FIELD

The present invention relates to a thermoplastic resin composition and a molded article formed therefrom. More specifically, the present invention relates to a thermoplastic resin composition having excellent impact resistance, flowability, appearance characteristics, or the like and a low dielectric constant, dielectric loss rate, or the like, and a molded article formed therefrom.

### BACKGROUND ART

Thermoplastic resin compositions comprising polycarbonate resins have lower specific gravity than glass and metal and exhibit excellent physical properties such as moldability and impact resistance, and thus they are useful for housings of electrical/electronic products, interior/exterior materials for automobiles, and exterior materials for construction.

However, when such thermoplastic resin compositions are used for purposes such as housings for mobile phones, there is a problem that communication performance deteriorates due to the high dielectric constant. Recently, with the development of mobile phone communication networks, the frequency range is changing to a (ultra) high frequency band, and so the application of materials having a low dielectric constant and a low dielectric loss rate as housing materials for mobile phones, or the like is becoming an essential requirement.

Therefore, there is a need to develop a thermoplastic resin composition having excellent impact resistance, flowability, appearance characteristics, or the like and a low dielectric constant, dielectric loss rate, or the like.

The related art of the present invention is disclosed in Korean Patent Publication No. 10-2018-0136559, or the like.

### DISCLOSURE

### Technical Problem

It is one object of the present invention to provide a thermoplastic resin composition having excellent impact resistance, flowability, appearance characteristics, or the like and a low dielectric constant and dielectric loss rate, or the like.

It is another object of the present invention to provide a molded article formed of the thermoplastic resin composition.

The above and other objects of the present invention can be achieved by embodiments of the present invention described below.

### Technical Solution

1. One aspect of the present invention relates to a thermoplastic resin composition. The thermoplastic resin composition comprises about 100 parts by weight of a polycarbonate resin; about 20 to 55 parts by weight of a polyphenylene ether resin; about 10 to 55 parts by weight of glass fiber; about 1 to 35 parts by weight of a styrene-ethylene/butylene-styrene copolymer; and about 0.2 to 4 parts by weight of dihydro-9-oxa-10-phosphaphenanthrene-10-oxide (DOPO).

2. In embodiment 1 above, the polyphenylene ether resin may comprise a repeating unit represented by Chemical Formula 1 below:

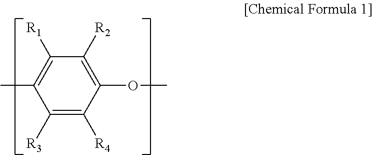

in Chemical Formula 1 above, R₁, R₂, R₃, and R₄ are each independently a hydrogen atom, a halogen atom, a C1 to C6 alkyl group or a C6 to C12 aryl group.

3. In embodiment 1 or 2 above, the styrene-ethylene/butylene-styrene copolymer may have a melt flow index (MI) of about 10 to 50 g/10 min, as measured under conditions of 200° C. and 5 kgf according to ASTM D1238.

4. In embodiments 1 to 3 above, a weight ratio of the glass fiber and the styrene-ethylene/butylene-styrene copolymer may be about 1:0.03 to about 1:1.

5. In embodiments 1 to 4 above, a weight ratio of the glass fiber and the DOPO may be about 1:0.02 to about 1:0.1.

6. In embodiments 1 to 5 above, a weight ratio of the styrene-ethylene/butylene-styrene copolymer and the DOPO may be about 1:0.04 to about 1:1.

7. In embodiments 1 to 6 above, the thermoplastic resin composition may have a notched Izod impact strength of about 6 to 20 kgf·cm/cm, as measured with a ⅛″ thick specimen according to ASTM D256.

8. In embodiments 1 to 7 above, the thermoplastic resin composition may have a melt flow index (MI) of about 20 to 55 g/10 min, as measured under conditions of 300° C. and 1.2 kgf according to ASTM D1238.

9. In embodiments 1 to 8 above, the thermoplastic resin composition may have a glossiness of about 87 to 97 GU, as measured at a reflection angle of 60° according to ASTM D523.

10. In embodiments 1 to 9 above, the thermoplastic resin composition may have a dielectric constant (Dk) of about 2.60 to about 3.01, as measured with a specimen having a size of 2.5 mm×50 mm×90 mm at 3.1 GHz using a split post dielectric resonator (SPDR) method.

11. In embodiments 1 to 10 above, the thermoplastic resin composition may have a dielectric loss rate (Df) of about 0.0040 to about 0.0051, as measured with a specimen having a size of 2.5 mm×50 mm×90 mm at 3.1 GHz using a split post dielectric resonator (SPDR) method.

12. Another aspect of the present invention relates to a molded article. The molded article is formed of the thermoplastic resin composition according to any one of embodiments 1 to 11.

### Advantageous Effects

The present invention has an effect of providing a thermoplastic resin composition with excellent impact resistance, flowability, appearance characteristics, or the like and a low dielectric constant and dielectric loss rate, or the like, and a molded article formed therefrom.

### BEST MODE

Hereinafter, embodiments of the present invention will be described in detail.

A thermoplastic resin composition according to the present invention comprises: (A) a polycarbonate resin; (B) a polyphenylene ether resin; (C) glass fiber; (D) a styrene-ethylene/butylene-styrene copolymer; and (E) DOPO.

As used herein to represent a specific numerical range, “a to b” means “≥a and ≤b”.

### (A) Polycarbonate Resin

As a polycarbonate resin according to one embodiment of the present invention, a polycarbonate resin used in conventional thermoplastic resin compositions may be used. For example, an aromatic polycarbonate resin prepared by reacting diphenols (aromatic diol compounds) with precursors, such as phosgene, halogen formate, and carbonic acid diester, may be used.

In an embodiment, examples of the diphenols may comprise 4,4′-biphenol, 2,2-bis(4-hydroxyphenyl)propane, 2,4-bis(4-hydroxyphenyl)-2-methylbutane, 1,1-bis(4-hydroxyphenyl)cyclohexane, 2,2-bis(3-chloro-4-hydroxyphenyl)propane, 2,2-bis(3,5-dichloro-4-hydroxyphenyl)propane, 2,2-bis(3-methyl-4-hydroxyphenyl)propane, and 2,2-bis(3,5-dimethyl-4-hydroxyphenyl)propane, but are not limited thereto. For example, 2,2-bis(4-hydroxyphenyl)propane, 2,2-bis(3,5-dichloro-4-hydroxyphenyl)propane, 2,2-bis(3,5-dimethyl-4-hydroxyphenyl)propane, or 1,1-bis(4-hydroxyphenyl)cyclohexane may be used, and specifically, 2,2-bis(4-hydroxyphenyl)propane, which is referred to as bisphenol-A, may be used.

In an embodiment, the polycarbonate resin may be one with a branched chain, for example, a branched polycarbonate resin prepared by adding, based on total diphenols used in polymerization, about 0.05 to 2 mol % of a trivalent or higher polyfunctional compound, specifically, a compound having a trivalent or higher phenol group.

In an embodiment, the polycarbonate resin may be used in the form of a homopolycarbonate resin, a copolycarbonate resin, or a blend thereof. In addition, the polycarbonate resin may be partially or entirely replaced with an aromatic polyester-carbonate resin obtained by polymerization in the presence of an ester precursor, for example, a difunctional carboxylic acid.

In an embodiment, the polycarbonate resin may have a weight average molecular weight (Mw) of about 10,000 to 50,000 g/mol, for example, about 15,000 to 40,000 g/mol, as measured by gel permeation chromatography (GPC). Within the above range, the flowability, or the like of a thermoplastic resin composition may be excellent.

### (B) Polyphenylene Ether Resin

As a polyphenylene ether resin according to one embodiment of the present invention, a polyphenylene ether resin that is used in a conventional thermoplastic resin composition may be used if it is capable of lowering the dielectric constant, dielectric loss rate, or the like of a thermoplastic resin composition using the characteristics of having a dielectric constant and a dielectric loss rate lower than those of a polycarbonate resin. For example, a polyphenylene ether resin comprising a repeating unit represented by Chemical Formula 1 below may be used.

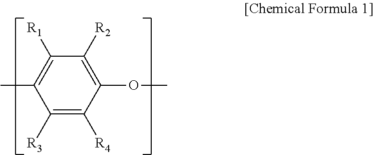

In Chemical Formula 1 above, R₁, R₂, R₃, and R₄ are each independently a hydrogen atom, a halogen atom, a C1 to C6 alkyl group or a C6 to C12 aryl group.

In an embodiment, examples of the polyphenylene ether resin may comprise poly(1,4-phenylene) ether, poly(2,6-dimethyl-1,4-phenylene) ether, and poly(2,6-diethyl-1,4-phenylene) ether, poly(2,6-dipropyl-1,4-phenylene) ether, poly(2-methyl-6-ethyl-1,4-phenylene) ether, poly(2-methyl)-6-propyl-1,4-phenylene) ether, poly(2-ethyl-6-propyl-1,4-phenylene) ether, poly(2,6-diphenyl-1,4-phenylene) ether, a copolymer of poly(2,6-diphenyl-1,4-phenylene) ether and poly(2,3,6-trimethyl-1,4-phenylene) ether, and a copolymer of poly(2,6-dimethyl-1,4-phenylene) ether and poly(2,3,5-triethyl-1,4-phenylene) ether.

In an embodiment, the polyphenylene ether resin may have a weight average molecular weight of about 10,000 to 50,000 g/mol, for example, about 20,000 to 40,000 g/mol, as measured by gel permeation chromatography (GPC).

In an embodiment, the polyphenylene ether resin may be comprised in an amount of about 20 to 55 parts by weight, for example, about 30 to 50 parts by weight, based on about 100 parts by weight of the polycarbonate resin. When the content of the polyphenylene ether resin is less than about 20 parts by weight based on about 100 parts by weight of the polycarbonate resin, there is a concern that the dielectric constant, dielectric loss rate, or the like of a thermoplastic resin composition (molded article) may increase, and when it exceeds about 55 parts by weight, there is a concern that the flowability, or the like of a thermoplastic resin composition (molded product) may be reduced.

### (C) Glass Fiber

As the glass fiber according to one embodiment of the present invention, a low-dielectric glass fiber used in a conventional low-dielectric thermoplastic resin composition may be used if it is capable of improving mechanical properties of a thermoplastic resin composition, such as rigidity and impact resistance, and lowering the dielectric constant, or the like thereof.

In an embodiment, the glass fiber may be in the form of a fiber and may have a cross-section of various shapes such as circular, oval, or rectangular. For example, it may be preferable in terms of mechanical properties to use a fibrous glass fiber with a circular and/or rectangular cross-section.

In an embodiment, the glass fiber with a circular cross-section may have a cross-sectional diameter of 5 to 20 μm and a length before processing of 2 to 20 mm, and the glass fiber with a rectangular cross-section may have a cross-sectional aspect ratio (the major diameter of the cross-section/the minor diameter of the cross-section may) of 1.5 to 10, a minor diameter of 2 to 10 μm, and a length before processing of 2 to 20 mm. Within the above ranges, the rigidity, processability, or the like of a thermoplastic resin composition may be improved.

In an embodiment, the glass fiber may be treated with a conventional surface treatment agent. As the surface treatment agent, a silane-based compound, a urethane-based compound, an epoxy-based compound, or the like may be used, but it is not limited thereto.

In an embodiment, the glass fiber may be comprised in an amount of about 10 to 55 parts by weight, for example, about 20 to 50 parts by weight, based on about 100 parts by weight of the polycarbonate resin. When the content of the glass fiber is less than about 10 parts by weight based on about 100 parts by weight of the polycarbonate resin, there is a concern that the impact resistance, rigidity, or the like of a thermoplastic resin composition (molded article) may be reduced, and the molded article may be twisted or bent, and when it exceeds about 55 parts by weight, there is a concern that the flowability, appearance characteristics, or the like of a thermoplastic resin composition (molded product) may be reduced, and the dielectric constant, dielectric loss rate, or the like may increase.

### (D) Styrene-Ethylene/Butylene-Styrene Copolymer

As the styrene-ethylene/butylene-styrene copolymer according to one embodiment of the present invention, a styrene-ethylene/butylene-styrene copolymer applied to a conventional thermoplastic resin composition may be used, and when applied together with DOPO, or the like, it is capable of improving the impact resistance, flowability, or the like of a thermoplastic resin composition comprising a polycarbonate resin, a polyphenylene ether resin, and a glass fiber and lowering the dielectric constant, dielectric loss rate, or the like thereof.

In an embodiment, the styrene-ethylene/butylene-styrene copolymer may have a melt flow index (MI) of about 10 to 50 g/10 min, for example, about 12 to 48 g/10 min, as measured under conditions of 200° C. and 5 kgf according to ASTM D1238. Within the above range, the thermoplastic resin composition may have excellent impact resistance, flowability, or the like.

In an embodiment, the styrene-ethylene/butylene-styrene copolymer may be comprised in an amount of about 1 to 35 parts by weight, for example, about 1.8 to 28 parts by weight, based on about 100 parts by weight of the polycarbonate resin. When the content of the styrene-ethylene/butylene-styrene copolymer is less than about 1 part by weight based on about 100 parts by weight of the polycarbonate resin, there is a concern that the impact resistance, or the like of a thermoplastic resin composition (molded article) may be reduced, and when it exceeds about 35 parts by weight, there is a concern that the flowability, or the like of a thermoplastic resin composition (molded article) may be reduced.

In an embodiment, the weight ratio (C:D) of the glass fiber (C) and the styrene-ethylene/butylene-styrene copolymer (D) may be from about 1:0.03 to about 1:1, for example, about 1:0.04 to about 1:0.8. Within the above range, the thermoplastic resin composition (molded article) may have better impact resistance, flowability (moldability), or the like.

### (E) Dihydro-9-oxa-10-phosphahenanthrene-10-oxide (DOPO)

As the dihydro-9-oxa-10-phosphahenanthrene-10-oxide (9,10-dihydro-9-oxa-10-phosphahenanthrene-10-oxide, DOPO) according to one embodiment of the present invention, DOPO used in a conventional thermoplastic resin composition may be used, and when applied together with a styrene-ethylene/butylene-styrene copolymer, or the like, it is capable of improving the impact resistance, flowability, appearance characteristics, or the like of a thermoplastic resin composition comprising a polycarbonate resin, a polyphenylene ether resin, and a glass fiber and lowering the dielectric constant, dielectric loss rate, or the like thereof.

In an embodiment, the DOPO may be comprised in an amount of about 0.2 to 4 parts by weight, for example, about 1 to 2 parts by weight, based on about 100 parts by weight of the polycarbonate resin. When the content of DOPO is less than about 0.2 parts by weight based on about 100 parts by weight of the polycarbonate resin, there is a concern that the flowability, appearance characteristics, thermal stability, or the like of a thermoplastic resin composition (molded article) may be reduced, and when it exceeds about 4 parts by weight, there is a concern that the impact resistance, or the like of the thermoplastic resin composition (molded article) may be reduced, and the dielectric constant, dielectric loss rate, or the like may increase.

In an embodiment, the weight ratio (C:E) of the glass fiber (C) and the DOPO (E) may be from about 1:0.02 to about 1:0.1, for example, from about 1:0.02 to about 1:0.08. Within the above range, the thermoplastic resin composition (molded article) may have better impact resistance, appearance characteristics, flowability (moldability), or the like.

In an embodiment, the weight ratio (D:E) of the styrene-ethylene/butylene-styrene copolymer (D) and the DOPO (E) may be from about 1:0.04 to about 1:1, for example, from about 1:0.05 to about 1:0.9. Within the above range, the thermoplastic resin composition (molded article) may have better impact resistance, appearance characteristics, flowability (moldability), or the like.

The thermoplastic resin composition according to one embodiment of the present invention may further comprise additives comprised in a conventional thermoplastic resin composition. Examples of the additives may comprise, flame retardants, antioxidants, anti-dripping agents, lubricants, release agents, nucleating agents, antistatic agents, stabilizers, pigments, dyes, and mixtures thereof, but are not limited thereto. When the additive is used, the content thereof may be about 0.001 to 40 parts by weight, for example, about 0.1 to 10 parts by weight, based on about 100 parts by weight of the polycarbonate resin.

The thermoplastic resin composition according to one embodiment of the present invention may be in the form of a pellet produced by mixing the above components and melt-extruding the same using a conventional twin-screw extruder at about 200 to 300° C., for example, about 220 to 280° C.

In an embodiment, the thermoplastic resin composition may have a notched Izod impact strength of about 6 to 20 kgf·cm/cm, for example, about 6 to 11 kgf·cm/cm, as measured with of a ⅛″ thick specimen according to ASTM D256.

In an embodiment, the thermoplastic resin composition may have a melt flow index (MI) of about 20 to 55 g/10 min, for example, 20 to 50 g/10 min, as measured under conditions of 300° C. and 1.2 kgf according to ASTM D1238.

In an embodiment, the thermoplastic resin composition may have a glossiness of about 87 to 97 GU, for example, about 89 to 96 GU, as measured at a reflection angle of 60° according to ASTM D523.

In an embodiment, the thermoplastic resin composition may have a dielectric constant (Dk) of about 2.60 to about 3.01, for example, about 2.80 to about 3.01, as measured with a specimen having a size of 2.5 mm×50 mm×90 mm at 3.1 GHz using a split post dielectric resonator (SPDR) method (using DAK3.5-TL-P (200 MHz-20 GHz) equipment and DAK1.2E-PL probe).

In an embodiment, the thermoplastic resin composition may have a dielectric loss rate (Df) of about 0.0040 to about 0.0051, for example, about 0.0043 to about 0.0051, as measured with a specimen having a size of 2.5 mm×50 mm×90 mm at 3.1 GHz using a split post dielectric resonator (SPDR) method (using DAK3.5-TL-P (200 MHz-20 GHz) equipment and DAK1.2E-PL probe).

The molded article according to the present invention is formed from the thermoplastic resin composition. The thermoplastic resin composition may be manufactured in the form of a pellet, and the manufactured pellet may be manufactured into various molded articles (products) through various molding methods such as injection molding, extrusion molding, vacuum molding, and casting molding. These molding methods are well known to those skilled in the art. The molded article has excellent impact resistance, flowability, appearance characteristics, or the like and a low dielectric constant and dielectric loss rate, and thus is useful as a housing for electrical and electronic products and a housing for mobile devices such as smartphones.

### MODE FOR INVENTION

Next, the present invention will be described in more detail with reference to some examples. It should be understood that these examples are provided for illustration only and are not to be construed in any way as limiting the present invention.

### Example

Details of components used in Examples and Comparative Examples are as follows:
(A) Polycarbonate resin

A bisphenol-A-based polycarbonate resin (manufacturer: Lotte Chemical, weight average molecular weight: approximately 22,000 g/mol) was used.
(B) Polyphenylene ether resin

A poly(1,4-phenylene) ether resin (manufacturer: Bluestar New Chemical Material Co., Ltd., product name: LXR-035) was used.
(C) Glass fiber

Circular cross-section glass fiber (manufacturer: Owens Corning, product name: 952-10P) was used.
(D) A styrene-ethylene/butylene-styrene copolymer (SEBS, manufacturer: Kraton Corp., product name: G1651) was used.
(D′) A maleic anhydride-modified styrene-ethylene/butylene-styrene copolymer (SEBS-g-MAH, manufacturer: Polyalloy, product name: PL6010) was used.
(E) Dihydro-9-oxa-10-phosphapheneanthrene-10-oxide (DOPO) (manufacturer: Shouguang Weidong Chemical Co., Ltd., product name: DOPO) was used.

### Examples 1 to 8 and Comparative Examples 1 to 9

Each of the above components was added in the contents shown in Tables 1, 2, 3, and 4 below, and then extruded at about 280° C. to manufacture pellets. For extrusion, a twin-screw extruder with L/D=44 and a diameter of 45 mm was used, and the manufactured pellets were dried at approximately 80° C. for more than 4 hours and then subjected to injection molding in a 6 oz injection molding machine (molding temperature: approximately 300° C., mold temperature: approximately 70° C.) to manufacture specimens. The physical properties of the manufactured specimens were evaluated by the methods below, and the results are shown in Tables 1, 2, 3, and 4 below.

### Property Evaluation

(1) Impact resistance (units: kgf·cm/cm): According to ASTM D256, the notched Izod impact strength of a ⅛″ thick specimen was measured.

(2) Flowability (units: g/10 min): According to ASTM D1238, the melt flow index (MI) was measured under conditions of 300° C. and 1.2 kgf.

(3) Appearance characteristics (units: GU): According to ASTM D523, the glossiness of an injection molded specimen with a size of 100 mm×100 mm×3.2 mm was measured at a reflection angle of 600 using a glossmeter (manufacturer: BYK Instruments, instrument name: micro gloss).

(4) Dielectric constant: Using a split post dielectric resonator (SPDR) (using DAK3.5-TL-P (200 MHz-20 GHz) equipment and DAK1.2E-PL probe), the dielectric constant (Dk) of a specimen with a size of 2.5 mm×50 mm×90 mm was measured at 3.1 GHz.

(5) Dielectric loss rate: Using a split post dielectric resonator (SPDR) (using DAK3.5-TL-P (200 MHz-20 GHz) equipment and DAK1.2E-PL probe), the dielectric loss rate (Df) of a specimen with a size of 2.5 mm×50 mm×90 mm was measured at 3.1 GHz.

TABLE 1

| | Examples | | | |
|---|---|---|---|---|
| | 1 | 2 | 3 | 4 |
| (A) (Parts by weight) | 100 | 100 | 100 | 100 |
| (B) (Parts by weight) | 30 | 44 | 44 | 44 |
| (C) (Parts by weight) | 36 | 36 | 20 | 36 |
| (D) (Parts by weight) | 12.7 | 12.7 | 12.7 | 1.8 |
| (D′) (Parts by weight) | — | — | — | — |
| (E) (Parts by weight) | 1.5 | 1.5 | 1.5 | 1.5 |
| Notched Izod impact | 7.4 | 7.3 | 6.4 | 6.3 |
| strength | | | | |
| Melt flow index | 40.2 | 34.9 | 48.1 | 46.2 |
| Glossiness | 92.3 | 92.1 | 95.8 | 92.2 |
| Dielectric constant | 3.004 | 2.961 | 2.884 | 3.007 |
| Dielectric loss rate | 0.00501 | 0.00494 | 0.00442 | 0.00502 |

TABLE 2

| | Examples | | | |
|---|---|---|---|---|
| | 5 | 6 | 7 | 8 |
| (A) (Parts by weight) | 100 | 100 | 100 | 100 |
| (B) (Parts by weight) | 44 | 44 | 44 | 44 |
| (C) (Parts by weight) | 36 | 36 | 36 | 36 |
| (D) (Parts by weight) | 27 | 12.7 | 12.7 | 27 |
| (D′) (Parts by weight) | — | — | — | — |
| (E) (Parts by weight) | 1.5 | 1 | 2 | 2 |
| Notched Izod impact | 8.6 | 8.1 | 6.9 | 7.2 |
| strength | | | | |
| Melt flow index | 28.4 | 33.4 | 35.1 | 34.4 |
| Glossiness | 92.1 | 91.2 | 94.6 | 94.4 |
| Dielectric constant | 2.947 | 2.945 | 2.976 | 2.956 |
| Dielectric loss rate | 0.00485 | 0.00485 | 0.00499 | 0.00490 |

TABLE 3

| | Comparative Examples | | | |
|---|---|---|---|---|
| | 1 | 2 | 3 | 4 |
| (A) (Parts by weight) | 100 | 100 | 100 | 100 |
| (B) (Parts by weight) | 15 | 60 | 44 | 44 |
| (C) (Parts by weight) | 36 | 36 | 5 | 60 |
| (D) (Parts by weight) | 12.7 | 12.7 | 12.7 | 12.7 |
| (D′) (Parts by weight) | — | — | — | — |
| (E) (Parts by weight) | 1.5 | 1.5 | 1.5 | 1.5 |
| Notched Izod impact | 7.6 | 7.1 | 5.8 | 8.6 |
| strength | | | | |
| Melt flow index | 43.1 | 13.4 | 50.2 | 19.4 |
| Glossiness | 92.2 | 92.1 | 98.4 | 90.2 |
| Dielectric constant | 3.051 | 2.918 | 2.747 | 3.141 |
| Dielectric loss rate | 0.00512 | 0.00464 | 0.00428 | 0.00531 |

TABLE 4

| | Comparative Examples | | | | |
|---|---|---|---|---|---|
| | 5 | 6 | 7 | 8 | 9 |
| (A) (Parts by weight) | 100 | 100 | 100 | 100 | 100 |
| (B) (Parts by weight) | 44 | 44 | 44 | 44 | 44 |
| (C) (Parts by weight) | 36 | 36 | 36 | 36 | 36 |
| (D) (Parts by weight) | 0.5 | 40 | — | 12.7 | 12.7 |
| (D′) (Parts by weight) | — | — | 12.7 | — | — |
| (E) (Parts by weight) | 1.5 | 1.5 | 1.5 | 0.1 | 4.5 |
| Notched Izod impact | 5.1 | 9.6 | 6.4 | 10.2 | 4.3 |
| strength | | | | | |
| Melt flow index | 48.2 | 14.1 | 30.2 | 24.4 | 61.8 |
| Glossiness | 92.3 | 92.1 | 92.0 | 64.3 | 97.4 |
| Dielectric constant | 3.152 | 2.933 | 3.251 | 2.918 | 3.078 |
| Dielectric loss rate | 0.00542 | 0.00478 | 0.00540 | 0.00465 | 0.00520 |

From the results above, it can be seen that the thermoplastic resin composition of the present invention has excellent impact resistance, flowability, appearance characteristics, or the like and a low dielectric constant and dielectric loss rate.

On the other hand, it can be seen that in the case of Comparative Example 1 in which a small amount of the polyphenylene ether resin was applied, the dielectric constant and dielectric loss rate increased; in the case of Comparative Example 2 in which an excessive amount of the polyphenylene ether resin was applied, flowability was reduced; in the case of Comparative Example 3 in which a small amount of glass fiber was applied, impact resistance was reduced; and in the case of Comparative Example 4 in which an excessive amount of glass fiber was applied, flowability was reduced, and the dielectric constant and the dielectric loss rate increased. It can be seen that in the case of Comparative Example 5 in which a small amount of the styrene-ethylene/butylene-styrene copolymer was applied, the dielectric constant and the dielectric loss rate increased; in the case of Comparative Example 6 in which an excessive amount of the styrene-ethylene/butylene-styrene copolymer was applied, flowability was reduced; and in the case of Comparative Example 7 in which the SEBS-gMAH (D′) was applied instead of the styrene-ethylene/butylene-styrene copolymer of the present invention, the dielectric constant and the dielectric loss rate increased. In addition, it can be seen that in the case of Comparative Example 8 in which a small amount of DOPO was applied, the appearance characteristics were reduced; and in the case of Comparative Example 9 in which an excessive amount of DOPO was applied, impact resistance was reduced, and the dielectric constant and the dielectric loss rate increased.

Although some example embodiments have been described herein, it will be understood by those skilled in the art that various modifications, changes, and alterations can be made without departing from the spirit and scope of the invention. Therefore, it should be understood that these embodiments are provided for illustration only and are not to be construed in any way as limiting the present invention. The scope of the present invention should be defined by the appended claims rather than by the foregoing description, and the claims and equivalents thereto are intended to cover such modifications and the like as would fall within the scope of the present invention.

1. A thermoplastic resin composition comprising:
about 100 parts by weight of a polycarbonate resin;
about 20 to 55 parts by weight of a polyphenylene ether resin;
about 10 to 55 parts by weight of glass fiber;
about 1 to 35 parts by weight of a styrene-ethylene/butylene-styrene copolymer; and
about 0.2 to 4 parts by weight of dihydro-9-oxa-10-phosphaphenanthrene-10-oxide (DOPO).

2. The thermoplastic resin composition according to claim 1, wherein the polyphenylene ether resin comprises a repeating unit represented by Chemical Formula 1 below: 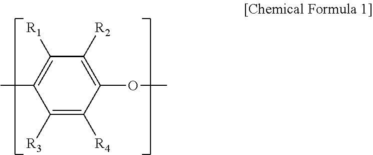
wherein in Chemical Formula 1 above, R₁, R₂, R₃, and R₄ are each independently a hydrogen atom, a halogen atom, a C1 to C6 alkyl group or a C6 to C12 aryl group.

3. The thermoplastic resin composition according to claim 1, wherein the styrene-ethylene/butylene-styrene copolymer has a melt flow index (MI) of about 10 to 50 g/10 min, as measured under conditions of 200° C. and 5 kgf according to ASTM D1238.

4. The thermoplastic resin composition according to claim 1, wherein a weight ratio of the glass fiber and the styrene-ethylene/butylene-styrene copolymer is about 1:0.03 to about 1:1.

5. The thermoplastic resin composition according to claim 1, wherein a weight ratio of the glass fiber and the DOPO is about 1:0.02 to about 1:0.1.

6. The thermoplastic resin composition according to claim 1, wherein a weight ratio of the styrene-ethylene/butylene-styrene copolymer and the DOPO is about 1:0.04 to about 1:1.

7. The thermoplastic resin composition according to claim 1, wherein the thermoplastic resin composition has a notched Izod impact strength of about 6 to 20 kgf·cm/cm, as measured with a ⅛″ thick specimen according to ASTM D256.

8. The thermoplastic resin composition according to claim 1, wherein the thermoplastic resin composition has a melt flow index (MI) of about 20 to 55 g/10 min, as measured under conditions of 300° C. and 1.2 kgf according to ASTM D1238.

9. The thermoplastic resin composition according to claim 1, wherein the thermoplastic resin composition has a glossiness of about 87 to 97 GU, as measured at a reflection angle of 60° according to ASTM D523.

10. The thermoplastic resin composition according to claim 1, wherein the thermoplastic resin composition has a dielectric constant (Dk) of about 2.60 to about 3.01, as measured with a specimen having a size of 2.5 mm×50 mm×90 mm at 3.1 GHz using a split post dielectric resonator (SPDR) method.

11. The thermoplastic resin composition according to claim 1, wherein the thermoplastic resin composition has a dielectric loss rate (Df) of about 0.0040 to about 0.0051, as measured with a specimen having a size of 2.5 mm×50 mm×90 mm at 3.1 GHz using a split post dielectric resonator (SPDR) method.

12. A molded article formed of the thermoplastic resin composition according to claim 1.
